(19) United States
(12) Patent Application Publication
(10) Pub. No.: US 2020/0353589 A1
(43) Pub. Date: Nov. 12, 2020

(54) WORKPIECE SPINDLE FOR A MAGNETIC-SHOE EXTERNAL CYLINDRICAL GRINDING MACHINE, AND MAGNETIC-SHOE EXTERNAL CYLINDRICAL GRINDING MACHINE

(71) Applicant: Schaeffler Technologies AG & Co. KG, Herzogenaurach (DE)

(72) Inventors: Helmut Sturm, Martkbergel (DE); Klaus Pichl, Herzogenaurach (DE)

(73) Assignee: Schaeffler Technologies AG & Co. KG, Herzogenaurach (DE)

(21) Appl. No.: 16/642,195

(22) PCT Filed: Aug. 22, 2018
(86) PCT No.: PCT/DE2018/100728

§ 371 Date: Feb. 26, 2020

(30) Foreign Application Priority Data
Sep. 5, 2017 (DE) 10 2017 120 333.8

(51) Int. Cl. B24B 41/04

(52) U.S. Cl. CPC B24B 41/044

(57) ABSTRACT

A workpiece spindle for a magnetic-shoe external cylindrical grinding machine a spindle for rotating a ring-shaped workpiece, a holding device for holding the ring-shaped workpiece and a hydraulic magnetic core lifting device coupled to the spindle and to the holding device to vary an axial spacing between the holding device and the spindle. The holding device has a magnetic shoe for clamping the ring-shaped workpiece in the holding device.

### CROSS-REFERENCE TO RELATED APPLICATIONS

This application is the United States National Phase of PCT Appln. No. PCT/DE2018/100728 filed Aug. 22, 2018, which claims priority to German Application No. DE102017120333.8 filed Sep. 5, 2017, the entire disclosures of which are incorporated by reference herein.

### TECHNICAL FIELD

The disclosure relates to a workpiece spindle for a magnetic-shoe external cylindrical grinding machine by means of which a workpiece can be held secure and rotated during grinding.

### BACKGROUND

During the cylindrical grinding of a workpiece, the workpiece can be held secure using jaws or magnetic shoes which grip the outer lateral surface and rotated with the help of a spindle, while a rotating grinding disk grips the outer lateral surface of the workpiece.

### SUMMARY

According to the disclosure, a workpiece spindle is provided for a magnetic-shoe external cylindrical grinding machine having a spindle for rotating a workpiece and a holding device for holding the workpiece. The holding device has a holding shoe configured as a magnetic shoe for clamping the workpiece in the holding device and a hydraulic magnetic core lifting device coupled to the spindle and to the holding device to vary an axial spacing between the holding device and the spindle.

With the help of the hydraulic magnetic core lifting device, the holding device can be extended and retracted in an axial direction, while the spindle can remain axially immobile. This makes it possible, for example, for the workpiece being ground to be positioned in automated fashion, for example with the help of a pivoting arm and/or a loading mandrel, in an axial direction in front of the spindle and the holding device and to be extended subsequently with the help of the hydraulic magnetic core lifting device, in order to hold the workpiece secure magnetically. Where necessary, the holding device can then be moved in slightly in order to receive the workpiece and moved away from a tool which has positioned the workpiece axially relative to the holding device. A collision between the workpiece spindle and the tool can thereby be avoided. In particular, it is possible for the tool to be moved in a plane perpendicular to the axial direction of the workpiece spindle and not to have to be displaced in an axial direction, in order to avoid unwanted striking of the tool and/or the workpiece. The automated delivery of the workpiece can thereby be simplified and take place more cost-effectively.

In addition, it is possible for the holding device to grip the workpiece with a beveled bearing surface and center the workpiece automatically on the holding device through the axial relative movement achieved with the hydraulic magnetic core lifting device. In this way, the holding device can be supported on the tool which has positioned the workpiece in front of the holding device and can thereby press the workpiece onto the holding device. A centering error can thereby be minimized, so that particularly during cylindrical grinding a uniform material thickness can be achieved with the ring-shaped workpiece. Particularly in the case of the workpiece, it is possible to allow it to have straps projecting axially from a ring-shaped body. Through the axial displacement of the holding device, the axially projecting fingers can grip the ring body so that a very high precision in relation to the axial ring width of the workpiece can be achieved during the surface grinding of the end face of the workpiece facing away from the straps. A reference point provided on the end face of the straps for measuring the ring width can thereby be avoided, so that tolerances in the axial length of the straps cannot influence the precision of the axial ring width. The manufacturing precision is thereby increased. By means of the holding device which can be axially displaced with the help of the hydraulic magnetic core lifting device, automated delivery of the workpiece can take place in a more cost-effective manner and greater precision can be achieved during manufacture of the workpiece, so that cost-effective grinding of ring-shaped workpieces is made possible with greater precision.

In particular, the holding device is designed to rest against the ring-shaped workpiece from radially within. It is thereby possible for the holding device with a beveled lateral surface which is part of a truncated cone, for example, to grip the inner diameter of the ring-shaped workpiece. By means of the axial displacement of the holding device facilitated by the hydraulic magnetic core lifting device, the workpiece can be positioned axially in front of the holding device without striking it and said holding device may dip into the ring-shaped workpiece following axial extension and it automatically centers the workpiece on the holding device. In this case, the ring-shaped workpiece may, in particular, be pressed onto the beveled lateral surface of the holding device. Since the ring-shaped workpiece is not held from radially outwards, but from radially inwards, it is possible in principle for the entire outer lateral surface of the workpiece to be ground without a machined part of the workpiece having to be pierced by an unmachined part or the workpiece having to be received between two tips.

The holding device is preferably configured to leave the workpiece freely accessible radially outwardly and on a first end face pointing away from the spindle. For example, the ring-shaped workpiece is positioned and fastened on the holding device on only one axial side, so that the outer lateral surface and the first end face are accessible for a grinding disk. This makes it possible in the case of the workpiece for both cylindrical grinding and also planar grinding to be undertaken without the workpiece having to be unclamped from the holding device for this purpose. This means that the cost associated with an additional machine tool can be saved.

Particularly preferably, the holding device has multiple axial stops offset relative to one another in the circumferential direction for axial striking against a second end face of the workpiece facing the spindle, particularly in a recessed position. The axial stops may, in particular, each be provided with fingers projecting in an axial direction on an end face pointing towards the workpiece. Straps projecting axially from a ring body of the workpiece may dip into the intermediate spaces formed between the fingers, so that the axial stops can strike the ring body of the workpiece at the end face between the straps. When the exposed first end face of the workpiece is surface-ground, the second end face pointing to the spindle between the straps can be used as the reference point for the axial extent of the ring width of the workpiece, so that the desired ring width can be achieved with high precision, even when there are high tolerance requirements.

In particular, the holding device has a magnetic device for holding the workpiece secure magnetically. Frictionally engaged wedging and/or pressing of the workpiece with the holding device can thereby be avoided or reduced. Instead of this, the workpiece can be held secure solely, or at least proportionately, magnetically by the holding device. The magnetic device preferably has an electromagnet so that the magnetic force that can be applied to hold the workpiece secure can be switched off for the insertion of the workpiece and/or for the removal of the workpiece. The automatic handling of the workpiece during the delivery and removal of said workpiece can thereby be simplified and, at the same time, a good hold of the particularly ferromagnetic workpiece in the holding mechanism can be achieved.

The holding device preferably has an exchangeable adapter for receiving the workpiece, wherein the adapter is particularly configured to receive more than one differently formed workpiece. The adapter can be easily exchanged, so that the workpiece spindle can be easily and cost-effectively adapted to other workpieces which are to be manufactured. In addition, the adapter may have functional surfaces adapted for different workpieces, so that more than one kind of workpiece can be received. Hence, for example, a lateral surface for a workpiece with a smaller internal diameter may project more in the axial direction than a lateral surface for a workpiece with a greater internal diameter. The hydraulic magnetic core lifting device means that the axial displacement of the different lateral surfaces can be balanced, so that both workpieces can be positioned at the same axial distance from the spindle. An automated delivery device for delivering and/or removing the workpiece can thereby be reused, leading to cost savings.

According to the invention, the holding device has holding shoes configured as a magnetic shoe for clamping the workpiece in the holding device. The holding shoes may form a tray in this case on which the workpiece can be deposited before the holding device can be extended to receive the workpiece. The holding shoes may preferably form an axial stop for the workpiece and/or exert sufficient holding force on the workpiece for the holding device not to push the workpiece away in an axial direction when moving out.

In particular, a locking device is provided for holding the spindle secure. During cylindrical grinding, the locking of the spindle can be released, so that both the workpiece and also the grinding disk can rotate. During surface-grinding of the end face of the workpiece, it may be sufficient for only the grinding disk to rotate and the spindle to be held secure by the locking device. In this way, defined relative movements result during surface grinding which allow a high degree of precision.

The disclosure further relates to a magnetic-shoe external cylindrical grinding machine for the cylindrical grinding and surface-grinding of ring-shaped workpieces having a workpiece spindle according to the disclosure for holding the workpiece during grinding. A first grinding disk is provided for the cylindrical grinding of a radially outer lateral surface of the workpiece and a second grinding disk is provided for the surface-grinding of a first end face of the workpiece, or a grinding disk is provided both for cylindrical grinding of the radially outer lateral surface of the workpiece and also for surface-grinding of the first end face of the workpiece. Different grinding disks or a common grinding disk can be used for cylindrical grinding and surface grinding. By means of the holding device which can be axially displaced with the help of the lifting device, automated delivery of the workpiece can take place more cost-effectively and greater precision can be achieved during manufacture of the workpiece, so that cost-effective grinding of ring-shaped workpieces can be achieved with high precision.

A feed arm is preferably provided for delivering a plurality of individual workpieces to the holding device. The feed arm has a movable loading mandrel for displacing the workpiece. The loading mandrel can be positioned in an axial direction in front of the spindle and/or in front of the holding device. Multiple workpieces can be placed for grinding in the feed arm, which workpieces can be separated with the help of a separating device. The individual workpiece can be received by the loading mandrel and, in particular, positioned within a plane running perpendicular to the axial direction of the workpiece spindle in front of the holding device. For this purpose, the loading mandrel can be guided along a linear guide, for example, and/or moved about a pivoting point along with the workpiece on a circular track. After grinding, the loading mandrel may receive the workpiece again and move it back into the feed arm where the workpiece can be removed away from the loading mandrel. After this, a further individual workpiece can be positioned by the loading mandrel in front of the holding device of the workpiece spindle. The delivery and removal of the workpiece in this case may take place in automated fashion.

### BRIEF DESCRIPTION OF THE DRAWINGS

The invention is explained by way of example below with reference to the attached drawings with the help of preferred exemplary embodiments, wherein the features depicted below may each represent an aspect of the invention individually, and also in combination. In the drawings:

FIG. 1 shows a schematic sectional view of a workpiece spindle for a magnetic-shoe external cylindrical grinding machine,

FIG. 2 shows a schematic perspective view of an adapter for the workpiece spindle from FIG. 1,

FIG. 3 shows a schematic rear view of a feed arm for delivering an annular workpiece to the workpiece spindle from FIG. 1, and

FIG. 4 shows a schematic front view of the feed arm from FIG. 3.

### DETAILED DESCRIPTION

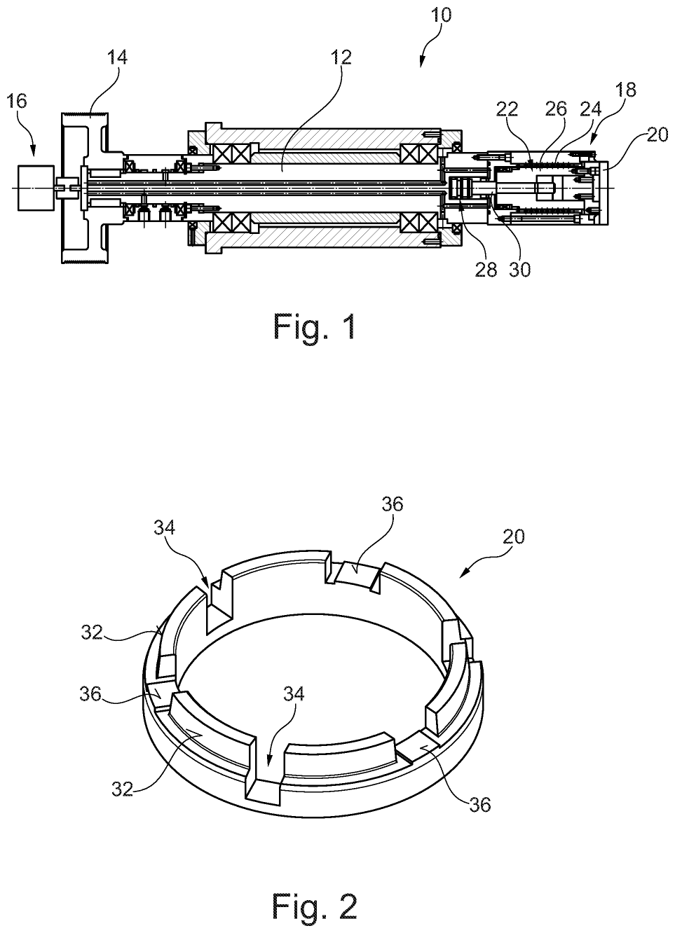

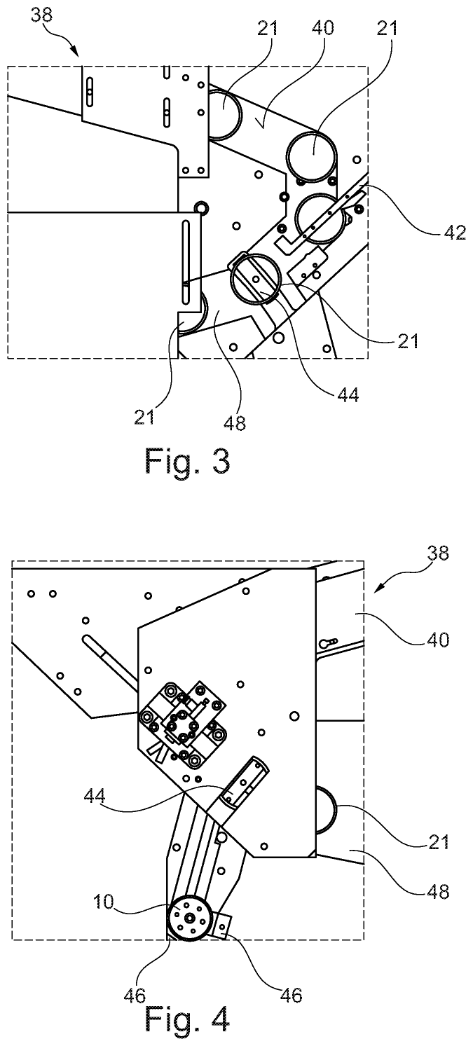

The workpiece spindle 10 depicted in FIG. 1 for a magnetic-shoe external cylindrical grinding machine has a spindle 12 which can be set in rotation via a belt pulley 14, for example, with the help of a wrap-around means driven by a motor. The angular position of the spindle 12 can be measured with the help of an encoder 16. The workpiece spindle 10 has a holding device 18 which can hold a ring-shaped workpiece 21 (ref. FIG. 3 and FIG. 4) secure for the grinding process via an exchangeable adapter 20. For this purpose, a magnetic device 22 interacting with magnetic shoes 46 (cf. FIG. 4) is provided in which a switchable electrically connected coil 24 with an iron core 26 forms an electromagnet. The holding device 18 is movably configured in an axial direction relative to the spindle 12 via a hydraulically operable magnetic core lifting device 28. For this purpose, the hydraulic magnetic core lifting device 28 may have a piston 30 guided in the spindle 12 in an axial direction which is connected to the holding device 18 via the iron core 26, for example.

In order to insert an annular workpiece 21, the hydraulic magnetic core lifting device 28 may introduce the holding device 18, so that the workpiece 21 can be positioned in an axial direction in front of the holding device 18. Thereafter, the holding device 18 can be extended and receive the workpiece 21 with the adapter 20. The adapter 20 depicted in FIG. 2 may have an outer lateral surface 32 that is beveled in a conical manner for this purpose, with which the ring-shaped workpiece 21 can be received in a centered fashion from radially within. In particular, the adapter 20 has recesses 34 extending in an axial direction into which straps projecting axially from a ring body of the workpiece 21 can project. With the help of the encoder 16, the spindle 12 and the holding device 18 connected to the spindle 12 via the hydraulic magnetic core lifting device 28 can be rotated into an angular position in which the projecting straps of the workpiece 21 positioned in a defined angular position in front of the holding device 18 can dip into the recesses 34 in the adapter 20 without striking the adapter 20 or another component. The adapter 20 also has multiple, for example exactly three, axial stops 36 which may strike the workpiece 21, for example in order to limit the insertion depth of the outer lateral surface pressed into the inner diameter of the workpiece 21. In particular, the axial stops 36 do not strike the straps, but an end face of the ring body of the workpiece 21, from which the straps project axially, so that the contact of the axial stops 36 at the ring body of the workpiece 21 can be used as a reference point, so that during surface-grinding of the end face of the workpiece 21 pointing away from the spindle 12, an axial ring width of the ring body of the workpiece 21 can easily be manufactured with high precision.

In order to allow the ring-shaped workpiece 21 to be introduced, a feed arm 38 depicted in FIG. 3 and FIG. 4 can be provided in which the ring-shaped workpieces 21 can be held in an intake channel 40. With the help of a workpiece slide 42, the workpieces 21 can be separated and individually fed to a loading mandrel 44. The loading mandrel 44 may receive the ring-shaped workpiece 21 and position it in front of the workpiece spindle 10, for example through a pivoting movement about a spaced apart rotational axis. For example, the workpiece 21 may be deposited on magnetic shoes 46, wherein the loading mandrel 44 and/or the magnetic shoes 46 may preferably form an axial support when the adapter 20 of the holding device 18 is inserted into the ring-shaped workpiece 21. After grinding, the loading mandrel 44 can transport the finished workpiece 21 back into the feed arm 38 again, where the workpiece 21 can be removed via an outlet channel 48.

### REFERENCE NUMERALS

10 Workpiece spindle
12 Spindle
14 Belt pulley
16 Encoder
18 Holding device
20 Adapter
21 Workpiece
22 Magnetic device
24 Coil
26 Iron core
28 Lifting device
30 Piston
32 Outer lateral surface
34 Recess
36 Axial stop
38 Feed arm
40 Intake channel
42 Workpiece slide
44 Loading mandrel
46 Magnetic shoes
48 Outlet channel

1.-9. (canceled)

10. A workpiece spindle for a magnetic-shoe external cylindrical grinding machine comprising:
a spindle for rotating a ring-shaped workpiece;
a holding device for holding the ring-shaped workpiece, comprising:
a magnetic shoe for clamping the ring-shaped workpiece in the holding device; and
a hydraulic magnetic core lifting device coupled to the spindle and to the holding device to vary an axial spacing between the holding device and the spindle.

11. The workpiece spindle of claim 10, wherein the holding device is designed to rest against the ring-shaped workpiece from radially within.

12. The workpiece spindle of claim 10, wherein the holding device is configured to leave the ring-shaped workpiece freely accessible radially outwardly and on a first end face pointing away from the spindle.

13. The workpiece spindle of claim 10, wherein the holding device comprises a plurality of axial stops offset relative to one another in a circumferential direction for axial striking against a second end face of the ring-shaped workpiece facing the spindle in a recessed position.

14. The workpiece spindle of claim 10, wherein the holding device comprises a magnetic device for holding the ring-shaped workpiece secure magnetically.

15. The workpiece spindle of claim 10, wherein the holding device comprises an exchangeable adapter for receiving the ring-shaped workpiece.

16. The workpiece spindle of claim 15, wherein the exchangeable adapter is configured to receive more than one differently formed ring-shaped workpiece.

17. The workpiece spindle of claim 10, further comprising a locking device for holding the spindle secure.

18. A magnetic-shoe external cylindrical grinding machine for cylindrical grinding and surface-grinding of a ring-shaped workpiece comprising:
the workpiece spindle of claim 10 for holding the ring-shaped workpiece during grinding;
a first grinding disk for cylindrical grinding of a radially outer lateral surface of the ring-shaped workpiece; and
a second grinding disk for surface grinding of a first end face of ring-shaped workpiece.

19. The magnetic-shoe external cylindrical grinding machine of claim 18 further comprising a feed arm for delivering a plurality of individual ring-shaped workpieces to the holding device, wherein:
the feed arm comprises a movable loading mandrel for displacing the ring-shaped workpiece; and
the movable loading mandrel can be positioned in an axial direction in front of the spindle or in front of the holding device.

20. A magnetic-shoe external cylindrical grinding machine for cylindrical grinding and surface-grinding of a ring-shaped workpiece comprising:
the workpiece spindle of claim 10 for holding the ring-shaped workpiece during grinding;
a single grinding disk for:
cylindrical grinding of a radially outer lateral surface of the ring-shaped workpiece; and
surface grinding of a first end face of the ring-shaped workpiece.

21. The magnetic-shoe external cylindrical grinding machine of claim 20 further comprising a feed arm for delivering a plurality of individual ring-shaped workpieces to the holding device, wherein:
the feed arm comprises a movable loading mandrel for displacing the ring-shaped workpiece; and
the movable loading mandrel can be positioned in an axial direction in front of the spindle or in front of the holding device.
